(19) United States
(12) Patent Application Publication
(10) Pub. No.: US 2024/0249624 A1
(43) Pub. Date: Jul. 25, 2024

(54) SAFETY MANAGEMENT SYSTEM AND AUTONOMOUS CONTROL SYSTEM

(71) Applicant: HITACHI, LTD., Tokyo (JP)

(72) Inventors: Hiromichi ENDOH, Tokyo (JP); Noritaka MATSUMOTO, Tokyo (JP); Hiroshi IWASAWA, Tokyo (JP)

(21) Appl. No.: 18/290,311

(22) PCT Filed: Mar. 17, 2022
(86) PCT No.: PCT/JP2022/012269

§ 371 Date: Nov. 13, 2023

(30) Foreign Application Priority Data
May 26, 2021 (JP) 2021-088157

(51) Int. Cl. G08G 1/16; B60W 60/00; G08G 1/0967; H04W 4/44

(52) U.S. Cl. CPC G08G 1/164; B60W 60/0015; G08G 1/096725; G08G 1/096775; G08G 1/166; H04W 4/44; B60W 2556/20; B60W 2556/45

(57) ABSTRACT

A safety management system for recognizing surrounding conditions and transmitting first surrounding condition data, and for respectively indicating safety actions to a first autonomous traveling machine that autonomously travels on a given first travel route on the basis of the first surrounding condition data and to a second autonomous traveling machine that autonomously travels on a given second travel route. An extraction unit sets, on the second travel route, a verification point where the second autonomous traveling machine can be recognized by the first autonomous traveling machine, and extracts an operation state of the second autonomous traveling machine at the verification point from the first surrounding condition data. A verification unit compares an operation state transmitted from the second autonomous traveling machine at the verification point and the operation state extracted by the extraction unit to verify the soundness of control in the second autonomous traveling machine.

### TECHNICAL FIELD

The present invention relates to a safety management system and an autonomous control system.

### BACKGROUND ART

There has been known an autonomous vehicle and an autonomous robot (hereinafter, referred to as an autonomous traveling machine) having a capability of recognizing a state of an external environment by themselves by mounting a camera or a sensor thereon and autonomously traveling on a route given based on a recognition result. The autonomous traveling machine is combined with an operation management system that plans or corrects a destination and a traveling route of the autonomous traveling machine and gives an instruction of the planned or corrected destination and traveling route to the autonomous traveling machine, and is operated as an autonomous control system. Further, in the same work area, a plurality of autonomous control systems having different purposes and different operation entities may be operated together. In the autonomous control system, for a purpose of avoiding a collision between the autonomous traveling machines and a collision with a person or an obstacle, an efficient operation of the autonomous traveling machine, or the like, it may be necessary to collect sensing data of the external environment and external environment recognition data from the autonomous traveling machine via a communication unit, and give an instruction of a danger avoidance operation and a more efficient route to the autonomous traveling machine based on the collected data.

In the autonomous control system as described above, in both the autonomous traveling machine and the operation management system, since a control operation depends on the data received from the other party via the communication unit, it is essential to ensure reliability and authenticity of the data. When such data is tampered or forged, security and productivity of the entire autonomous control system may be significantly affected. Therefore, a security technique such as detection of data tamper and forgery is used.

Meanwhile, when the autonomous traveling machine loses a normal control capability, data different from an actual state of the external environment may be reported as the sensing data or external environment recognition. In such a case, since there is no error or tamper in the data itself, the security technique described above cannot cope with this problem. In such a case, as a technique in the related art in a viewpoint of functional safety and reliability, redundancy of control devices mounted on the autonomous traveling machine and addition of a device that monitors soundness of the autonomous traveling machine and the operation management system occur.

PTL 1 discloses a method of observing an operation state of an autonomous traveling machine by a sensing unit such as a camera provided in a work area and correcting an operation state reported by the autonomous traveling machine itself in comparison with the reported operation state.

### CITATION LIST

### Patent Literature

PTL 1: JP4056777B

### SUMMARY OF INVENTION

### Technical Problem

However, when the autonomous traveling machine loses the normal control capability due to an artificial cause such as a cyberattack, it may be difficult to perform detection by the redundancy or simple monitoring described above. For example, in the redundancy by the control devices of the same architecture, all the control devices may have the same vulnerability, and in this case, all the control devices lose the soundness due to the cyberattack.

Further, in a method of using a fixed monitoring device, an avoidance method such as a disguising behavior of normally behaving only in a region being monitored may be taken when the control on the autonomous traveling machine is taken away by an attacker.

The invention has been made in view of the technical problem described above, and a main object thereof is to detect an abnormality of an autonomous traveling machine whose control is taken away by an attacker.

### Solution to Problem

A safety management system according to a first aspect of the invention is a safety management system for giving an instruction of a safety-ensuring operation to each of a first autonomous traveling machine and a second autonomous traveling machine, the first autonomous traveling machine being configured to recognize a surrounding situation to transmit first surrounding situation data, transmit an own operation state, and autonomously travel on a given first traveling route based on the first surrounding situation data, the second autonomous traveling machine being configured to recognize a surrounding situation to transmit second surrounding situation data, transmit an own operation state, and autonomously travel on a given second traveling route based on the second surrounding situation data, and includes an extraction unit configured to set a verification point at which the second autonomous traveling machine is recognizable by the first autonomous traveling machine in the second traveling route and extract an operation state of the second autonomous traveling machine at the verification point from the first surrounding situation data, and a verification unit configured to compare an operation state transmitted from the second autonomous traveling machine at the verification point with the operation state extracted by the extraction unit to verify soundness of control on the second autonomous traveling machine.

An autonomous control system according to a second aspect of the invention includes: a first operation management system configured to transmit data of a first traveling route; a second operation management system configured to transmit data of a second traveling route; a first autonomous traveling machine configured to recognize a surrounding situation to transmit first surrounding situation data, transmit an own operation state, and autonomously travel on the first traveling route based on the first surrounding situation data; a second autonomous traveling machine configured to recognize a surrounding situation to transmit second surrounding situation data, transmit an own operation state, and autonomously travel on the second traveling route based on the second surrounding situation data; and the safety management system according to the first aspect.

### Advantageous Effects of Invention

According to the invention, it is possible to detect an abnormality of an autonomous traveling machine whose control is taken away by an attacker.

### BRIEF DESCRIPTION OF DRAWINGS

FIG. 1 is a block diagram showing an overall configuration of an autonomous control system according to a first embodiment of the invention.

FIG. 2 is a block diagram showing an internal configuration of an autonomous traveling machine.

FIG. 3 is a block diagram showing an internal configuration of an operation management system.

FIG. 4 is a block diagram showing an internal configuration of a safety management system.

FIG. 5 is a diagram showing a soundness verification operation of control on the autonomous traveling machine.

FIG. 6 is a flowchart showing an example of the soundness verification operation.

FIG. 7 is a diagram showing a verification operation between two autonomous traveling machines belonging to the same operation management system.

FIG. 8 is a flowchart showing a soundness verification operation according to Modification 1.

FIG. 9 is a flowchart showing Modification 2.

FIG. 10 is a diagram showing an autonomous control system according to a second embodiment.

FIG. 11 is a block diagram showing a configuration of an autonomous traveling machine according to the second embodiment.

### DESCRIPTION OF EMBODIMENTS

Hereinafter, embodiments according to the invention will be described with reference to the drawings.

### First Embodiment

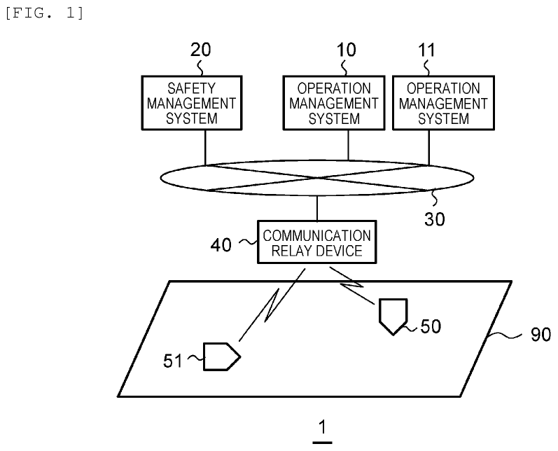

FIG. 1 is a block diagram showing an overall configuration of an autonomous control system 1 according to a first embodiment of the invention. In the autonomous control system 1, a first autonomous traveling machine 50 is an autonomous traveling machine belonging to a first operation management system 10, and a second autonomous traveling machine 51 is an autonomous traveling machine belonging to a second operation management system 11. The first operation management system 10 executes planning and instructions of a destination and a traveling route to the first autonomous traveling machine 50 belonging to the first operation management system 10. Meanwhile, the second operation management system 11 executes planning and instructions of a destination and a traveling route to the second autonomous traveling machine 51 belonging to the second operation management system 11. Both the first autonomous traveling machine 50 and the second autonomous traveling machine 51 are operated within a work area 90.

The operation management systems 10 and 11 are two different types of operation management systems, and correspond to, for example, an autonomous driving system of a shared bus and an autonomous driving system of a taxi, respectively. A safety management system 20 is a system that performs management such that the shared bus and the taxi that are operated in the same field (work area 90) can operate safely. In an example shown in FIG. 1, there is one autonomous traveling machine belonging to each of the first and second management systems 10 and 11, and in general, there is a plurality of autonomous traveling machines belonging thereto.

The safety management system 20 performs monitoring such that a problem such as a collision between the first autonomous traveling machine 50 and the second autonomous traveling machine 51 in the work area 90 and a collision between the first and second autonomous traveling machines 50 and 51 and another machine or a person (not shown). When a danger such as a collision is predicted, the first and second autonomous traveling machines 50 and 51 are instructed to perform a danger avoidance operation such as emergency braking.

The operation management systems 10 and 11, the safety management system 20, and a communication relay device 40 are connected to one another via a network 30. Wired and wireless communication in the network 30 and a type of a communication protocol used therein are not limited. The communication relay device 40 connects the first autonomous traveling machine 50 and the second autonomous traveling machine 51 to the network 30, and relays communication of the first autonomous traveling machine 50 and the second autonomous traveling machine 51 with the first operation management system 10 and the second operation management system 11 and communication of the first autonomous traveling machine 50 and the second autonomous traveling machine 51 with the safety management system 20.

In the following description, wireless communication such as an IEEE 802.11 series is assumed as a communication unit between the communication relay device 40, and the first autonomous traveling machine 50 and the second autonomous traveling machine 51, and is not limited thereto in the essence of the invention. The other communication unit including a wired communication unit may be used depending on aspects of the autonomous control system. When the network 30 uses a wireless communication unit, an aspect may be used in which the communication relay device 40 is omitted and the first autonomous traveling machine 50 and the second autonomous traveling machine 51 are directly connected to the network 30.

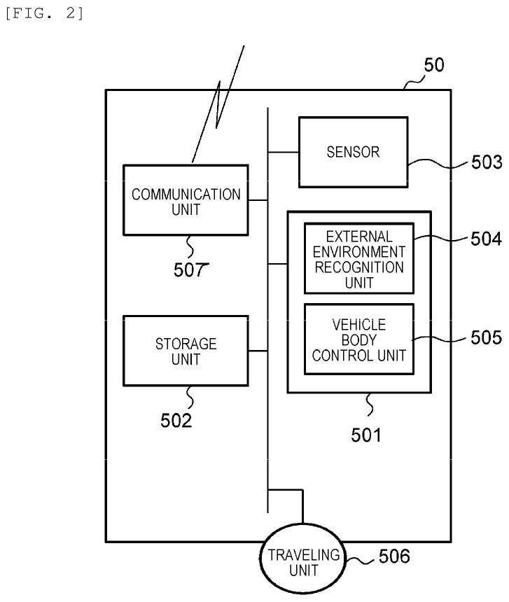

FIG. 2 is a block diagram showing an internal configuration of the first autonomous traveling machine 50. Although illustration and description are omitted, the second autonomous traveling machine 51 has the same configuration as that of the first autonomous traveling machine 50. The first autonomous traveling machine 50 includes a processor 501, a storage unit 502, a sensor 503, a traveling unit 506, and a communication unit 507. The storage unit 502 stores an external environment recognition program, a vehicle body control program, and the destination and the traveling route received, via the communication unit 507, from the operation management system 10 to which the first autonomous traveling machine 50 belongs. The processor 501 functions as an external environment recognition unit 504 and a vehicle body control unit 505 by executing the external environment recognition program and the vehicle body control program that are stored in the storage unit 502, respectively.

The external environment recognition unit 504 processes sensor detection data output from the sensor 503 to recognize a surrounding situation of the first autonomous traveling machine 50, and outputs an external environment recognition result thereof. The sensor detection data and data (surrounding situation data A0 described later) related to the surrounding situation including the external environment recognition result obtained by the external environment recognition unit 504 are reported to the operation management system 10 and the safety management system 20 via the communication unit 507. Similarly, data (surrounding situation data A1 described later) related to a surrounding situation acquired in the second autonomous traveling machine 51 is reported to the operation management system 11 and the safety management system 20.

The vehicle body control unit 505 determines a position, a traveling direction, a speed, a posture, and the like of the first autonomous traveling machine 50 itself based on the external environment recognition result of the external environment recognition unit 504, the destination, and the traveling route. Hereinafter, the own position, traveling direction, speed, and posture will be collectively referred to as an operation state. The traveling unit 506 generates a driving force based on data such as the traveling direction, the speed, and the posture determined by the vehicle body control unit 505.

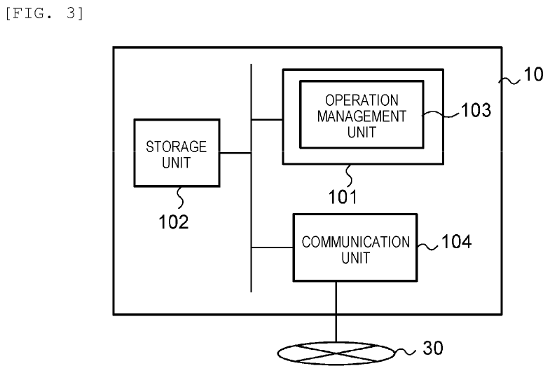

FIG. 3 is a block diagram showing an internal configuration of the operation management system 10. Although illustration and description are omitted, the operation management system 11 has the same configuration as that of the operation management system 10. The operation management system 10 can be implemented by a server or a personal computer equipped with a processor 101, a storage unit 102, and a communication unit 104. The storage unit 102 stores an operation management program, and the processor 101 functions as an operation management unit 103 by executing the operation management program.

In the operation management system 10, the data (surrounding situation data A0 to be described later) related to the surrounding situation of the first autonomous traveling machine 50 is reported from the first autonomous traveling machine 50 via the network 30. Details of the data related to the surrounding situation will be described later. The data related to the surrounding situation is input to the operation management unit 103 via the communication unit 104. The operation management unit 103 plans or corrects the destination and the traveling route of the first autonomous traveling machine 50 based on the reported data related to the surrounding situation of the first autonomous traveling 50, machine and gives instructions of the destination and the traveling route to the first autonomous traveling machine 50.

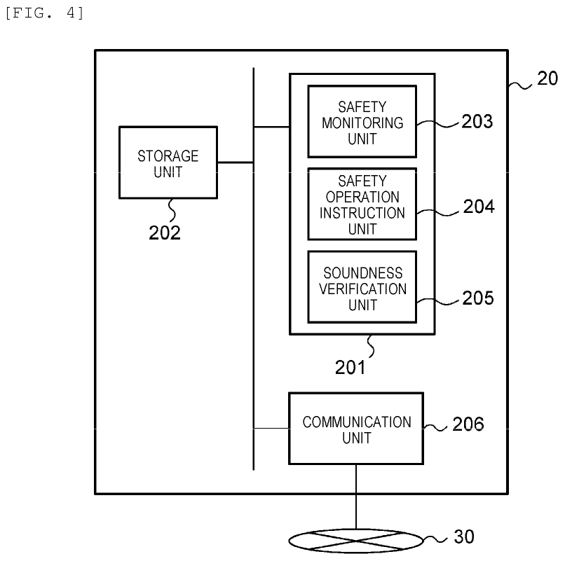

FIG. 4 is a block diagram showing an internal configuration of the safety management system 20. The safety management system 20 can be implemented by a general-purpose server or a personal computer equipped with a processor 201, a storage unit 202, and a communication unit 206. The storage unit 202 stores a safety monitoring program, a safety operation instruction program, and a soundness verification program. The processor 201 functions as a safety monitoring unit 203, a safety operation instruction unit 204, and a soundness verification unit 205 by executing the safety monitoring program, the safety operation instruction program, and the soundness verification program that are stored in the storage unit 202, respectively.

In the safety management system 20, data (surrounding situation data A0 and A1 to be described later) related to the surrounding situations of the first and second autonomous traveling machines 50 and 51 and data (operation state data B0 and B1 to be described later) related to the operation states thereof are reported from the first and second autonomous traveling machines 50 and 51, respectively, via the network 30. Further, in the safety management system 20, the traveling routes given from the operation management systems 10 and 11 to the first and second autonomous traveling machines 50 and 51 are also reported from the first and second autonomous traveling machines 50 and 51. The data and the traveling route described above may be received from the operation management systems 10 and 11 via the network 30.

The safety monitoring unit 203 determines safety states of the first and second autonomous traveling machines 50 and 51 based on the data (surrounding situation data A0 and A1 to be described later) related to the surrounding situations reported from the first and second autonomous traveling machines 50 and 51 and the data (operation state data B0 and B1 to be described later) related to operation states thereof. The safety operation instruction unit 204 gives an instruction of an operation related to safety ensuring to each of the first second autonomous traveling machines 50 and 51 based on safety state determination of the safety monitoring unit 203. The soundness verification unit 205 verifies soundness of control in the first and second autonomous traveling machines 50 and 51.

### <Description of Soundness Verification Operation>

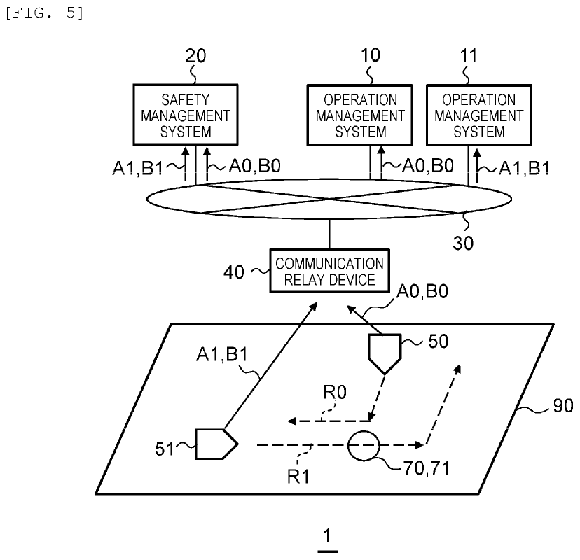

Next, an operation related to soundness verification in the soundness verification unit 205 will be described. FIG. 5 is a diagram showing a case of verifying the soundness of the control on the second autonomous traveling machine 51.

The first and second autonomous traveling machines 50 and 51 travel in the work area 90 according to traveling routes R0 and R1 instructed by the operation management systems 10 and 11 to which the first and second autonomous traveling machines 50 and 51 belong, respectively. During the traveling, the first autonomous traveling machine 50 reports the surrounding situation data A0 including the sensor detection data of the sensor 503 and the external environment recognition result of the external environment recognition unit 504, and the operation state data B0 determined by the vehicle body control unit 505 to the safety management system 20 and the operation management system 10 to which the first autonomous traveling machine 50 belongs at a predetermined cycle. Similarly, during the traveling, the second autonomous traveling machine 51 reports the surrounding situation data A1 including the sensor detection data of the sensor 503 and the external environment recognition result of the external environment recognition unit 504, and the operation state data B1 determined by the vehicle body control unit 505 to the safety management system 20 and the operation management system 11 to which the second autonomous traveling machine 51 belongs at a predetermined cycle.

### (Verification Point 70 and Verification Time 71)

The soundness verification unit 205 sets a verification point 70 and a verification time 71 at which the soundness verification of the control is executed on the traveling route R1 of the second autonomous traveling machine 51. In FIG. 5, the verification point 70 is schematically described on the traveling route R1. A substance thereof is coordinate data representing the same point, and is stored in the storage unit 202 of the safety management system 20. As the verification point 70, a point at which the first autonomous traveling machine 50 can observe the operation state of the second autonomous traveling machine 51 at a certain scheduled time from an own traveling route R0 is selected among points present on the traveling route R1 of the second autonomous traveling machine 51, and a scheduled time of the selected point is the verification time 71.

That is, when the second autonomous traveling machine 51 traveling on the traveling route R1 can be captured within an effective field of view of the sensor 503 mounted on the first autonomous traveling machine 50 at the verification time 71, and it can be predicted that a condition is satisfied under which the external environment recognition unit 504 mounted on the first autonomous traveling machine 50 can recognize the operation state of the second autonomous traveling machine 51, a scheduled point at which the second autonomous traveling machine 51 is present at the verification time 71 can be set as the verification point 70.

For example, when the whole or a part of the second autonomous traveling machine 51 is blocked by an obstacle or another autonomous traveling machine, the condition described above is not satisfied. When the second autonomous traveling machine 51 is not blocked by the obstacle or another autonomous traveling machine, the second autonomous traveling machine 51 is recognized at the verification point 70 by the first autonomous traveling machine 50 at the verification time 71. That is, at the verification time 71, when the obstacle or another autonomous traveling machine is not predicted between the first autonomous traveling machine 50 and the second autonomous traveling machine 51 or is not detected by the sensor 503 of the first autonomous traveling machine 50, the verification point 70 is set. However, at the verification time 71, when the obstacle or another autonomous traveling machine is predicted, or when the obstacle or another autonomous traveling machine is detected by the sensor 503 of the first autonomous traveling machine 50, the verification point 70 is not set.

The second autonomous traveling machine 51, which is a verification target, is not notified of the verification point 70 and the verification time 71. This is because, it is assumed that, when the second autonomous traveling machine 51 is temporarily under control of an attacker who has entered the network 30, if the attacker knows the verification point 70 and the verification time 71, the second autonomous traveling machine 51 behaves in a way of normally operating only in the vicinity of the verification point 70.

### (Soundness Verification Operation)

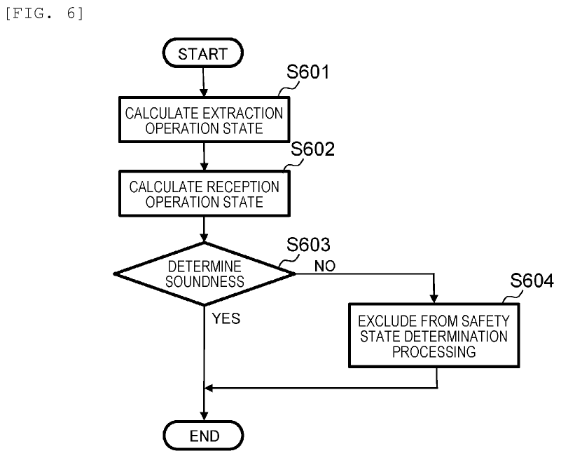

FIG. 6 is a flowchart showing an example of the soundness verification operation in the soundness verification unit 205. In step S601, the soundness verification unit 205 extracts the operation state (position, traveling direction, speed, and posture) of the second autonomous traveling machine 51 at the verification point 70, which is associated with the verification time 71, from the surrounding situation data A0 reported from the first autonomous traveling machine 50. Hereinafter, the operation state extracted in step S601 is referred to as an extraction operation state.

In step S602, the operation state associated with the verification time 71, that is, the operation state of the second autonomous traveling machine 51 at the verification point 70 is extracted from the operation state data B1 received from the second autonomous traveling machine 51. Hereinafter, the operation state extracted in step S602 is referred to as a reception operation state.

In step S603, it is determined whether a control state of the second autonomous traveling machine 51 is sound based on the extraction operation state extracted in step S601 and the reception operation state extracted in step S602. Then, when it is determined in step S603 that the control state of the second autonomous traveling machine 51 is sound (YES), a series of determination processing is ended, and when it is determined that the control state of the second autonomous traveling machine 51 is not sound (NO), a process proceeds to step S604.

The determination of whether the control state of the second autonomous traveling machine 51 is sound described above is performed by determining whether there is consistency between the extraction operation state and the reception operation state related to the operation state of the second autonomous traveling machine 51. For example, each of the extraction operation state and the reception operation state includes four elements (position, traveling direction, speed, and posture), and the soundness verification unit 205 obtains a difference for each of the corresponding elements included in the extraction operation state and the reception operation state. When the differences are within predetermined deviations, it is determined that the operation state reported from the second autonomous traveling machine 51 is reliable and the control state of the second autonomous traveling machine 51 is sound.

On the other hand, for at least one of the corresponding elements in the extraction operation state and the reception operation state, in a case where the difference between the elements exceeds the predetermined deviation or in a case where a content of the deviation is unreasonable, it is determined that the operation state reported from the second autonomous traveling machine 51 is not reliable and the control state of the second autonomous traveling machine 51 is not sound. The case where the content of the deviation is unreasonable is, for example, a case where a deviation in the traveling direction and a deviation in the posture are mechanically contradictory.

In step S604, the surrounding situation data A1 and the operation state data B1 that are reported from the non-sound second autonomous traveling machine 51 are considered to have low reliability, and all or a part of the data is excluded in safety state determination processing in the safety monitoring unit 203 of the safety management system 20.

In the first embodiment described above, a case has been described where the first autonomous traveling machine 50 monitors the second autonomous traveling machine 51, but conversely, the second autonomous traveling machine 51 monitors the first autonomous traveling machine 50, and the soundness verification unit 205 also performs soundness verification of control on the first autonomous traveling machine 50. That is, the autonomous traveling machines monitor each other.

FIG. 1 shows one autonomous traveling machine 50 belonging to the operation management system 10 and one autonomous traveling machine 51 belonging to the operation management system 11, and in general, there is a plurality of autonomous traveling machines belonging to each of the operation management systems 10 and 11. Even in such a case, by applying the control described above to the autonomous traveling machines, the soundness verification operation described above is performed between the autonomous traveling machines belonging to the operation management system 10 and the autonomous traveling machines belonging to the operation management system 11. In this case, the verification operation based on the surrounding situation data of each of the other plurality of autonomous traveling machines belonging to the operation management system 10 is performed on one autonomous traveling machine belonging to the operation management system 11, and therefore accuracy of the verification operation is further improved.

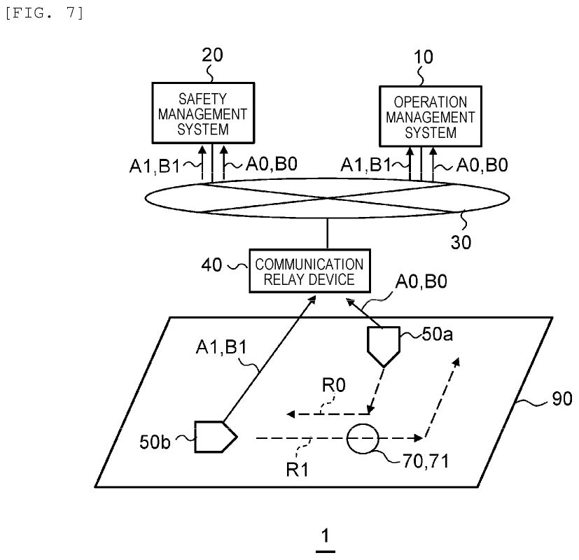

Further, as shown in FIG. 7, the verification operation described above may be performed between two autonomous traveling machines 50a and 50b belonging to the same operation management system 10. For example, when the autonomous traveling machine 50b takes an abnormal behavior due to a cyberattack, an operation state reported by the autonomous traveling machine 50b itself may be disguised. The operation state reported by the autonomous traveling machine 50b can be compared with an operation state of the autonomous traveling machine 50b which is included in surrounding situation data reported from the autonomous traveling machine 50a to verify soundness of control on the autonomous traveling machine 50b.

According to the first embodiment of the invention described above, the following effects are attained. (1) As shown in FIG. 5, the safety management system 20 gives an instruction of a safety-ensuring operation to the first autonomous traveling machine 50 configured to recognize the surrounding situation to transmit the first surrounding situation data A0, transmit the operation state data B0 representing an own operation state, and autonomously travel on the given first traveling route R0 based on the first surrounding situation data A0, and the second autonomous traveling machine 51 configured to recognize the surrounding situation to transmit the second surrounding situation data A1, transmit the operation state data B1 representing an own operation state, and autonomously travel on the given second traveling route R1 based on the second surrounding situation data A1. The safety management system 20 includes the soundness verification unit 205 as an extraction unit configured to set the verification point 70 at which the second autonomous traveling machine 51 is recognizable by the first autonomous traveling machine 50 in the second traveling route R1 and extract the operation state of the second autonomous traveling machine 51 at the verification point 70 from the first surrounding situation data A0. Further, the soundness verification unit 205 functions as a verification unit configured to compare the operation state data B1 as the operation state transmitted from the second autonomous traveling machine 51 at the verification point 70 with the operation state extracted from the first surrounding situation data A to verify the soundness of the control on the second autonomous traveling machine 51.

In this way, in the present embodiment, at the verification point 70 at which the second autonomous traveling machine 51 whose soundness is to be verified travels, the operation state of the second autonomous traveling machine 51 is recognized by the first autonomous traveling machine 50 which is a third party, and the recognized operation state is compared with the operation state reported by the second autonomous traveling machine 51 itself to detect an abnormality of the control on the second autonomous traveling machine 51 when a behavior different from the operation state reported by the second autonomous traveling machine 51 due to a failure, the cyberattack, or the like is shown.

For example, when the second autonomous traveling machine 51 takes an abnormal behavior due to the cyberattack, the second autonomous traveling machine 51 may disguise an actual operation state as an original correct operation state (operation state data B1) different from an actual behavior and report the same to the safety management system. In such a case, the abnormality of the second autonomous traveling machine 51 can also be detected by comparing the operation state (surrounding situation data A0) of the second autonomous traveling machine 51 recognized by the first autonomous traveling machine 50 that is not subjected to the cyberattack with the disguised operation state (operation state data B1) thereof.

When the behavior of the autonomous traveling machine is recognized and monitored by a fixed infrastructure sensor as in the related art, a disguising behavior of controlling the autonomous traveling machine in an original operation state and reporting an original operation state may only be taken in a monitorable range of the infrastructure sensor. In this case, since the operation state recognized by the infrastructure sensor matches the reported operation state, it is not possible to detect that the autonomous traveling machine is in an abnormal state due to the cyberattack.

On the other hand, in the present embodiment, the verification point 70 is set by the soundness verification unit 205 of the safety management system 20, and the operation state of the second autonomous traveling machine 51 at the verification point 70 is recognized by the first autonomous traveling machine 50 traveling in the work area 90. Therefore, it is possible to make it difficult for the second autonomous traveling machine 51 subjected to the cyberattack to avoid being observed by the first autonomous traveling machine 50 by the disguising behavior.

(2) Further, as shown in FIG. 7, the operation management system to which the autonomous traveling machine 50a belongs and the operation management system to which the autonomous traveling machine 50b belongs may be the same, the first traveling route R0 and the second traveling route R1 may be given from the same operation management system, and the soundness of the autonomous traveling machines belonging to the same operation management system can be verified.

(3) Preferably, the soundness verification unit 205 calculates the verification point at which the second autonomous traveling machine 51 is recognizable by the first autonomous traveling machine 50 based on the first and second traveling routes R0 and R1 and the first surrounding situation data A0. In this way, the verification point at which the second autonomous traveling machine 51 is not blocked by the obstacle such as a person or a moving object is reliably set based on the surrounding situation recognized by the first autonomous traveling machine 50, and the soundness verification can be performed with high accuracy.

### (Modification 1)

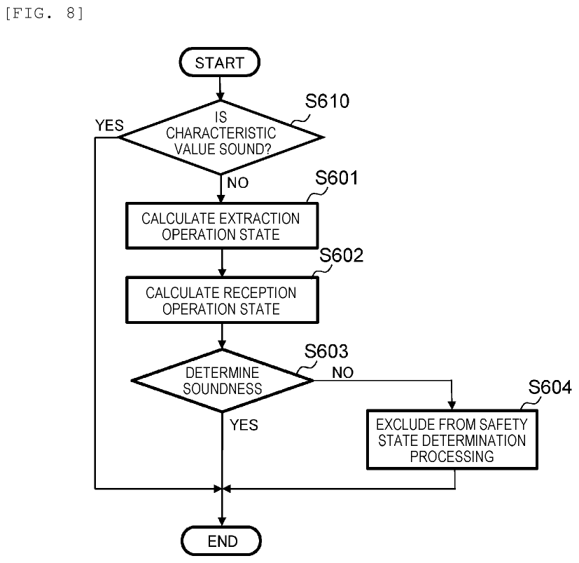

FIG. 8 is a flowchart showing Modification 1, in which processing of step S610 is added to the flowchart in FIG. 6. In Modification 1, soundness verification of a control state using the verification point 70 and the verification time 71 described above is executed only when occurrence of a cyberattack or the like is suspected.

First, in step S610, soundness of a communication characteristic value of data transmitted from the second autonomous traveling machine 51 to the safety management system 20 is verified. For example, for communication including the surrounding situation data A1 and the operation state data B1 that are transmitted from the second autonomous traveling machine 51 to the safety management system 20, a correlation of the feature values such as a communication cycle, a transmission destination, and a specification protocol is monitored, and the correlation of the feature values is checked over time by statistical processing. Then, when it is determined that there is soundness of the communication characteristic value (YES), a processing operation in FIG. 8 is ended without executing the soundness verification of the control on the second autonomous traveling machine 51.

On the other hand, when communication deviating from a normal correlation of the characteristic value which is usually seen is observed, that is, when the soundness of the communication characteristic value is denied in step S610 (NO), it is determined that there is a suspected cyberattack on the second autonomous traveling machine 51, and a process proceeds to step S601. Thereafter, as in the case in FIG. 6, the processing from step S601 to step S604 is executed, and the soundness verification of the control state using the verification point 70 and the verification time 71 is performed. As a correlation monitoring method, for example, existing techniques such as a support vector machine (SVM) or a k-nearest neighbor (k-NN) can be used.

(4) According to Modification 1, the following effects are attained.

The soundness verification unit 205 monitors a time correlation of the operation state data B1 received from the second autonomous traveling machine 51, sets the verification point 70 when data deviating from a normal time correlation is observed, and executes a soundness verification operation. That is, when a suspicious behavior is suspected due to the cyberattack from the operation state data B1 of the second autonomous traveling machine 51, the abnormality can be verified by immediately executing the soundness verification operation based on the observation of the first autonomous traveling machine 50.

### (Modification 2)

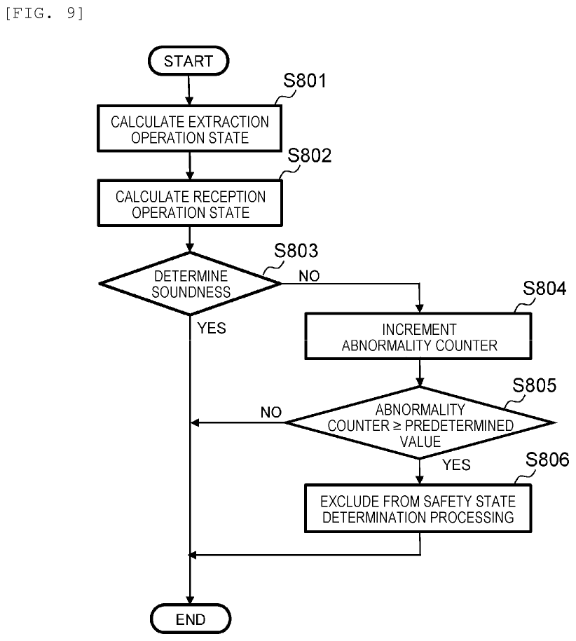

FIG. 9 is a flowchart showing Modification 2. In the soundness verification operation shown in FIG. 6, when the differences between the corresponding elements of the extraction operation state and the reception operation state exceed the predetermined deviations, or when the content of the deviation is unreasonable, it is determined that the control state of the second autonomous traveling machine 51 is not sound, and the data reported from the second autonomous traveling machine 51 is excluded in the safety state determination processing in the safety monitoring unit 203 of the safety management system 20. On the other hand, in a soundness verification operation according to Modification 2, determination related to reliability of an operation state reported from the second autonomous traveling machine 51 and soundness of a control state thereof is continuously or stepwise lowered depending on a magnitude of the deviation and a degree of irrationality.

In the flowchart shown in FIG. 9, processing of steps S801 to S803 and S806 is the same as the processing of steps S601 to S604 of the flowchart in FIG. 6, respectively. That is, in step S801, the extraction operation state of the second autonomous traveling machine 51 is obtained from the surrounding situation data A0 reported from the first autonomous traveling machine 50, and in step S802, the reception operation state of the second autonomous traveling machine 51 is obtained from the operation state data B1 received from the second autonomous traveling machine 51. In step S803, it is determined whether the control state of the second autonomous traveling machine 51 is sound based on the extraction operation state and the reception operation state.

When it is determined in step S803 that the control state of the second autonomous traveling machine 51 is sound (YES), a series of soundness verification processing is ended, and when it is determined that the control state of the second autonomous traveling machine 51 is not sound (NO), a process proceeds to step S804. In step S804, an abnormality counter indicating the degree of abnormality is incremented. In step S805, it is determined whether the abnormality counter is equal to or greater than a predetermined value. When the abnormality counter is equal to or greater than the predetermined value, the process proceeds to step S806, and the data reported from the second autonomous traveling machine 51 is excluded from safety state determination processing. On the other hand, when the abnormality counter is less than the predetermined value, the series of soundness verification processing is ended. The soundness verification operation shown in FIG. 6 corresponds to a case where the predetermined value in step S805 in FIG. 9 is set to 1.

In Modification 2, even when the deviation happens to increase due to an error when the second autonomous traveling machine 51 is normal, such a situation is rare. Therefore, it is determined that the abnormality counter<the predetermined value in step S805 and it is possible to avoid being immediately determined as abnormal. On the other hand, when the deviation is increased due to the abnormality, the abnormality counter is incremented every time the soundness verification operation in FIG. 9 is executed, and therefore the abnormality counter≥the predetermined value immediately and it is determined to be abnormal (YES) in step S805.

(5) According to Modification 2, the following effects are attained.

In Modification 2, as in the processing shown in FIG. 9, when it is determined that the second autonomous traveling machine 51 is not in the normal control state as a result of verifying the soundness of the control on the second autonomous traveling machine 51 (step S803), the soundness verification unit 205 decreases reliability of data related to the operation state transmitted from the second autonomous traveling machine 51 (step S804). Therefore, it is possible to prevent the second autonomous traveling machine 51 which is normal from being erroneously detected as abnormal.

Further, the autonomous control system 1 according to the first embodiment has the following effects.

(6) The autonomous control system 1 shown in FIG. 1 includes the first operation management system 10 configured to transmit data of the first traveling route R0, the second operation management system 11 configured to transmit data of the second traveling route R1, the first autonomous traveling machine 50 configured to recognize a surrounding situation to transmit the first surrounding situation data A0, transmit the operation state data B0 representing an own operation state, and autonomously travel on the first traveling route R0 based on the first surrounding situation data A0, the second autonomous traveling machine 51 configured to recognize a surrounding situation to transmit the second surrounding situation data A1, transmit the operation state data B1 representing an own operation state, and autonomously travel on the second traveling route R1 based on the second surrounding situation data A1, and the safety management system 20 described above.

In the autonomous control system 1 described above, at the verification point 70 at which the second autonomous traveling machine 51 whose soundness is to be verified travels, the operation state of the second autonomous traveling machine 51 is recognized by the first autonomous traveling machine 50 which is the third party, and the recognized operation state is compared with the operation state reported by the second autonomous traveling machine 51 itself to detect the abnormality of the control on the second autonomous traveling machine 51 when the behavior different from the operation state reported by the second autonomous traveling machine 51 due to the failure, the cyberattack, or the like is shown.

### Second Embodiment

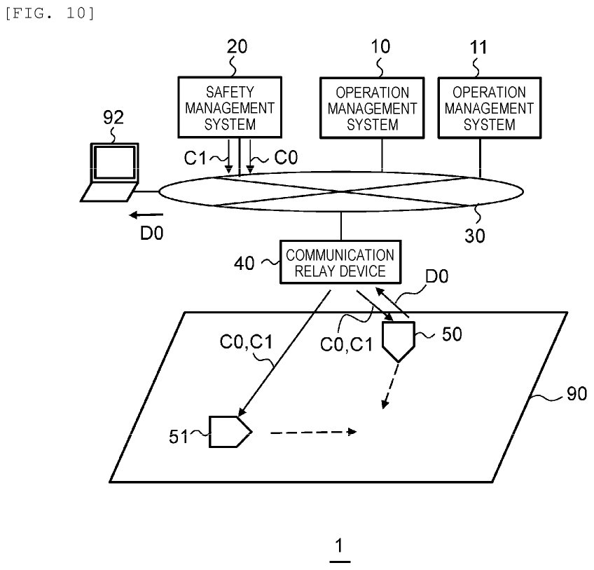

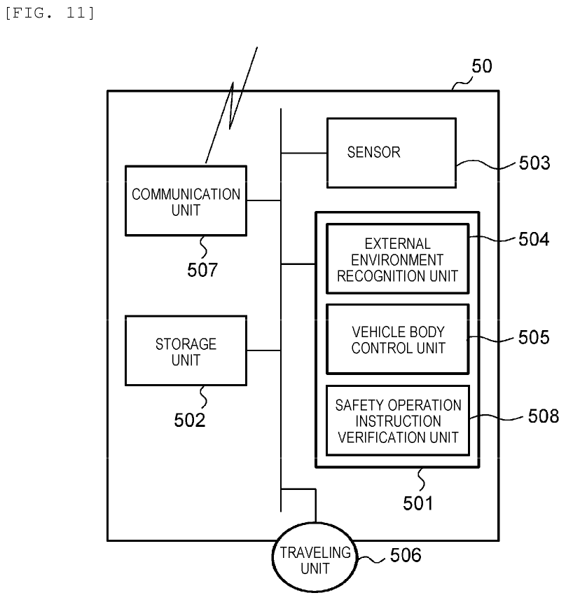

FIGS. 10 and 11 are diagrams showing the autonomous control system 1 according to a second embodiment. In the first embodiment described above, it is assumed that the second autonomous traveling machine 51 loses a normal control capability due to a cyberattack. To completely prepare for security of the autonomous control system 1, it is desirable to assume a case where a safety management system 20 side loses a normal control capability due to the cyberattack.

That is, when the safety management system 20 does not give an instruction of a safety operation having a necessary content at a necessary timing to the first and second autonomous traveling machines 50 and 51, conversely, or when the safety management system 20 gives an instruction of a safety operation having an unreasonable or improper content at an improper timing based on malice to the first and second autonomous traveling machines 50 and 51, security and productivity of the entire autonomous control system 1 may be impaired. In the second embodiment, a method for implementing soundness verification of a control state in the safety management system 20 on the assumption of such a case will be described.

FIG. 10 is a diagram showing the autonomous control system 1 according to the second embodiment, and an administrator terminal 92 is added to a system configuration of the autonomous control system shown in FIG. 1. A role of the administrator terminal 92 will be described later. FIG. 11 is a block diagram showing a configuration of the first autonomous traveling machine 50 according to the second embodiment. Although not shown, a configuration of the second autonomous traveling machine 51 is also the same as the configuration of the first autonomous traveling machine 50 shown in FIG. 11.

In the configuration of the first autonomous traveling machine 50 shown in FIG. 11, a safety operation instruction verification unit 508 is added to the configuration of the first autonomous traveling machine 50 shown in FIG. 2. That is, a safety operation instruction verification program is also stored in the storage unit 502, and the processor 501 also functions as the safety operation instruction verification unit 508 by executing the safety operation instruction verification program. An operation of the safety operation instruction verification unit 508 will be described later.

In the present embodiment, a description will be given of a case where a soundness verification method when the safety management system 20 side loses the normal control capability due to the cyberattack is further added to the autonomous control system that performs the soundness verification operation of the control on the autonomous traveling machine described in the first embodiment. However, the soundness verification method when the safety management system 20 side loses the normal control capability due to the cyberattack may be independently applied to an autonomous control system that does not perform the soundness verification operation of the control on the autonomous traveling machine described in the first embodiment.

FIG. 10 shows a state in which the first autonomous traveling machine 50 and the second autonomous traveling machine 51 are traveling on courses colliding with each other in the work area 90. When the external environment recognition units 504 of the first and second autonomous traveling machines 50 and 51 fail or cannot recognize each other due to an obstacle, the autonomous traveling machines 50 and 51 may collide with each other. To avoid such a collision, the safety management system 20 transmits first and second safety-ensuring operation instructions C0 and C1 to the first and second autonomous traveling machines 50 and 51, respectively. Specific contents of the first and second safety-ensuring operation instructions C0 and C1 are different depending on detected situations, and include, for example, forced braking or stopping, a change in a traveling direction, and a change in a posture, that is, a temporary change in an operation state.

Here, when the safety management system 20 loses the normal control capability and there is a contradiction or inconsistency in the contents of the first and second safety-ensuring operation instructions C0 and C1, for example, when a braking instruction is not issued to any of the first and second autonomous traveling machines 50 and 51 or an avoidance instruction in the same direction is issued to both of the first and second autonomous traveling machines 50 and 51, the security and productivity of the entire autonomous control system 1 are impaired as described above.

First, in the present embodiment, a configuration is used in which each of the first and second autonomous traveling machines 50 and 51 receives or intercepts both the first and second safety-ensuring operation instructions C0 and C1, that is, not only one addressed to the machine itself but also one addressed to the other party. The safety operation instruction verification unit 508 (see FIG. 11) provided in each of the first and second autonomous traveling machines 50 and 51 compares a temporary change instruction content of the operation state included in each of the received first and second safety-ensuring operation instructions C0 and C1, and confirms if there is any contradiction or inconsistency as described above.

When such a contradiction or inconsistency is detected in either or both of the first and second autonomous traveling machines 50 and 51, an autonomous traveling machine that detects the contradiction or inconsistency transmits a warning message to the administrator terminal 92 and the other autonomous traveling machine to notify the administrator terminal 92 and the other autonomous traveling machine of an abnormality of the safety management system 20, and executes a safety operation such as an emergency stop by itself through the vehicle body control unit 505. In the example shown in FIG. 10, such a contradiction or inconsistency is detected in the first autonomous traveling machine 50, and the first autonomous traveling machine 50 transmits a warning message DO to the administrator terminal 92 and the second autonomous traveling machine 51.

For example, the administrator terminal 92 is provided in the safety management system 20, and an administrator of the autonomous control system 1 monitors the administrator terminal 92. The administrator of the autonomous control system 1 can take measures such as system stopping and maintenance using the warning message DO displayed on the administrator terminal 92 as a trigger.

The safety operation instruction verification unit 508 may monitor a correlation of feature values such as a communication cycle, a transmission destination, and a specification protocol for communication transmitted from the safety management system 20 and including the first and second safety-ensuring operation instructions C0 and C1, and may collate the contents of the first and second safety-ensuring operation instructions C0 and C1 due to a suspicion of the cyberattack on the safety management system 20 when communication deviating from the correlation of the characteristic values is observed.

According to the second embodiment described above, the following effects are attained.

(7) In the autonomous control system 1 shown in FIGS. 10 and 11, the safety management system 20 transmits the first safety-ensuring operation instruction C0 related to the first autonomous traveling machine 50 and the second safety-ensuring operation instruction C1 related to the second autonomous traveling machine 51 to each of the first and second autonomous traveling machines 50 and 51. Further, each of the first and second autonomous traveling machines 50 and 51 further includes the safety operation instruction verification unit 508 which determines whether there is a contradiction or inconsistency between the first safety-ensuring operation instruction C0 and the second safety-ensuring operation instruction C1 and notifies the abnormality of the safety management system 20 when determining that there is a contradiction or inconsistency.

Therefore, mutual monitoring between the first and second autonomous traveling machines 50 and 51 and the safety management system 20 can be implemented in the autonomous control system 1, and the security of the autonomous control system 1 can be maintained even when any side loses the normal control capability and transmits improper external environment recognition data, operation state data, and a safety operation instruction.

(8) Further, the safety operation instruction verification unit 508 may monitor a time correlation for the first safety-ensuring operation instruction C0 and the second safety-ensuring operation instruction C1 that are received from the safety management system 20, and may determine whether there is a contradiction or inconsistency between the first safety-ensuring operation instruction C0 and the second safety-ensuring operation instruction C1 when data deviating from the time correlation is observed.

In the description described above, a functional unit in the configuration may be implemented by a program executed by a combination of a microcomputer, a processor, and arithmetic devices similar thereto, a ROM, a RAM, a flash memory, a hard disk, an SSD, a memory card, an optical disk, and storage devices thereto, a bus, a network, and communication devices similar thereto, and peripheral devices in addition to an electric circuit, an electronic circuit, a logic circuit, and an integrated circuit that incorporate the electric circuit, the electronic circuit, and the logic circuit. The invention can be implemented in either implementation mode.

The embodiments and the various modifications described above are merely examples, and the invention is not limited thereto as long as features of the invention are not impaired. Although various embodiments and various modifications have been described above, the invention is not limited to contents thereof. Other aspects conceivable within the scope of a technical idea of the invention are also included within the scope of the invention.

### REFERENCE SIGNS LIST

1: autonomous control system
10, 11: operation management system
20: safety management system
30: network
40: communication relay device
50, 51: autonomous traveling machine
90: work area
203: safety monitoring unit
204: safety operation instruction unit
205: soundness verification unit
503: sensor
504: external environment recognition unit
505: vehicle body control unit
508: safety operation instruction verification unit

1. A safety management system for giving an instruction of a safety-ensuring operation to each of a first autonomous traveling machine and a second autonomous traveling machine, the first autonomous traveling machine being configured to recognize a surrounding situation to transmit first surrounding situation data, transmit an own operation state, and autonomously travel on a given first traveling route based on the first surrounding situation data, the second autonomous traveling machine being configured to recognize a surrounding situation to transmit second surrounding situation data, transmit an own operation state, and autonomously travel on a given second traveling route based on the second surrounding situation data, the safety management system comprising:
an extraction unit configured to set a verification point at which the second autonomous traveling machine is recognizable by the first autonomous traveling machine in the second traveling route and extract an operation state of the second autonomous traveling machine at the verification point from the first surrounding situation data; and
a verification unit configured to compare an operation state transmitted from the second autonomous traveling machine at the verification point with the operation state extracted by the extraction unit to verify soundness of control on the second autonomous traveling machine.

2. The safety management system according to claim 1, wherein
the first traveling route and the second traveling route are given from the same operation management system.

3. The safety management system according to claim 1, wherein
the extraction unit calculates, based on the first and second traveling routes and the first surrounding situation data, the verification point at which the second autonomous traveling machine is recognizable by the first autonomous traveling machine.

4. The safety management system according to claim 1, wherein
the extraction unit monitors a time correlation of data related to the operation state transmitted from the second autonomous traveling machine and sets the verification point when data deviating from the time correlation is observed.

5. The safety management system according to claim 1, wherein
when it is determined that the second autonomous traveling machine is not in a normal control state as a result of verifying the soundness of the control on the second autonomous traveling machine, the verification unit decreases reliability of data related to the operation state transmitted from the second autonomous traveling machine.

6. An autonomous control system comprising:
a first operation management system configured to transmit data of a first traveling route;
a second operation management system configured to transmit data of a second traveling route;
a first autonomous traveling machine configured to recognize a surrounding situation to transmit first surrounding situation data, transmit an own operation state, and autonomously travel on the first traveling route based on the first surrounding situation data;
a second autonomous traveling machine configured to recognize a surrounding situation to transmit second surrounding situation data, transmit an own operation state, and autonomously travel on the second traveling route based on the second surrounding situation data; and
the safety management system according to claim 1.

7. The autonomous control system according to claim 6, wherein,
the safety management system transmits a first safety-ensuring operation instruction related to the first autonomous traveling machine and a second safety-ensuring operation instruction related to the second autonomous traveling machine to each of the first and second autonomous traveling machines, and
each of the first and second autonomous traveling machines further includes a safety operation instruction verification unit configured to determine whether there is a contradiction or inconsistency between the first and second safety-ensuring operation instructions, and give a notification of an abnormality of the safety management system when determining that there is a contradiction or inconsistency.

8. The autonomous control system according to claim 7, wherein
the safety operation instruction verification unit monitors a time correlation for the first and second safety-ensuring operation instructions received from the safety management system, and determines whether there is a contradiction or inconsistency between the first and second safety-ensuring operation instructions when data deviating from the time correlation is observed.
